(19) United States
(12) Patent Application Publication
(10) Pub. No.: US 2009/0198726 A1
(43) Pub. Date: Aug. 6, 2009

(54) METHOD AND APPARATUS FOR ORGANIZING CONTENTS

(75) Inventors: Sung-Won AHN, Seoul (KR); Chul-Young Choi, Seoul (KR); Sung-Soo Kim, Seoul (KR); Jung-Gil Yim, Seongnam-si (KR); Hyun-Jin Yang, Uijeongbu-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/272,996

(22) Filed: Nov. 18, 2008

(30) Foreign Application Priority Data
Feb. 4, 2008 (KR) 2008-11170

(51) Int. Cl. G06F 17/30

(52) U.S. Cl. 707/102; 707/E17.044

(57) ABSTRACT

A method and apparatus to organize content, which can systematically and efficiently organize and manage contents. The method includes creating a content list and providing the content list to a user; providing a user interface to the user to organize content included in the content list in units of time periods; storing organization schedule information organization schedule information obtained by the user interface as extensible Markup Language (XML) information; and transmitting the organization schedule information and enabling the content to be provided to the user according to the organization schedule information.

### CROSS-REFERENCE TO RELATED APPLICATION

This application claims the benefit of Korean Patent Application No. 2008-11170 filed in the Korean Intellectual Property Office on Feb. 4, 2008, the disclosure of which is incorporated herein by reference.

### BACKGROUND OF THE INVENTION

1. Field of the Invention

Aspects of the present invention relate to a method and apparatus to organize content, and more particularly, to a method and apparatus to organize content, which can systematically and efficiently organize and manage content.

2. Description of the Related Art

Content reproduction systems reproduce a plurality of content according to a predefined schedule. The organization of content is generally performed by content providers. Nowadays, however, even users can organize content provided by content providers.

The organization of content may be performed using a batch method, which is shown in FIG. 1. In the batch method, however, it is difficult to systematically manage content and to add, modify, and erase data. In order to add new data or modify existing data, all the existing data must be read out, thereby causing an unnecessary waste of resources. In addition, it is difficult to effectively visualize organization schedule information regarding the organization of content and priority information of each of the contents using the batch method.

### SUMMARY OF THE INVENTION

Aspects of the present invention provide a method and apparatus to organize content, which can systematically and efficiently organize and manage content.

According to an aspect of the present invention, a method of organizing content is provided. The method includes creating a content list and providing the content list to a user; providing a user interface to the user to organize content included in the content list in units of time periods; storing organization schedule information obtained by the user interface as extensible Markup Language (XML) information; and transmitting the organization schedule information and enabling the contents to be provided to a user according to the organization schedule information.

According to another aspect of the present invention, an apparatus to organize content is provided. The apparatus includes a content list providing module to create a content list and to provide the content list to a user; a storage module to store information; a content organization module to provide, to the user, a user interface to organize content included in the content list in units of time periods and to store organization schedule information obtained by the user interface in the storage module as XML information; and an organization schedule information transmission module to transmit the organization schedule information and to enable the content to be provided to the user according to the organization schedule information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a diagram of organization schedule information obtained by a conventional method of organizing content;

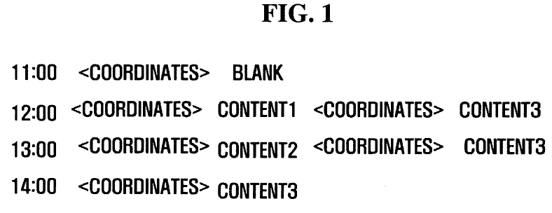

FIG. 2 illustrates a schematic diagram of a system to which an apparatus to organize content according to an embodiment of the present invention is applied;

FIG. 3 illustrates a block diagram of the apparatus illustrated in FIG. 2 according to an embodiment of the present invention;

FIG. 4 illustrates a diagram explaining the organization of content along a time axis of a content organization interface, according to an embodiment of the present invention;

FIG. 5 illustrates a diagram of a content organization field of a content organization interface including a time adjustment bar, according to an embodiment of the present invention;

FIG. 6 illustrates a diagram explaining the organization of content using a tree structure, according to an embodiment of the present invention;

FIG. 7 illustrates a diagram explaining the addition of new content to a content organization interface, according to an embodiment of the present invention;

FIG. 8 illustrates a diagram of a tree structure resulting from the addition of the new content to the content organization interface illustrated in FIG. 7, according to an embodiment of the present invention;

FIG. 9 illustrates a diagram of XML information resulting from the addition of the new content to the content organization interface illustrated in FIG. 7, according to an embodiment of the present invention; and

FIG. 10 illustrates a flowchart of a process of organizing content according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to flowchart illustrations of user interfaces, processes, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instructions implementing the operation specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus implement the operations specified in the flowchart block or blocks.

Each block of the flowchart illustrations may represent a module, segment, or portion of code, which comprises one or more executable instructions implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

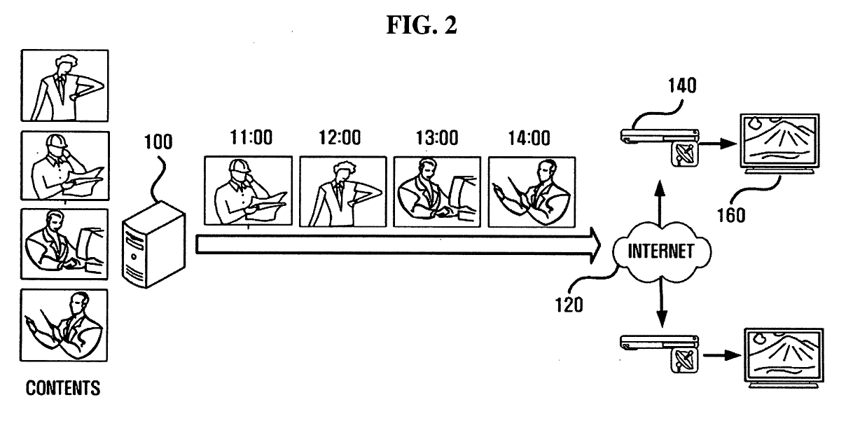

FIG. 2 shows a system to which an apparatus 100 to organize content according to an embodiment of the present invention is applied. The apparatus 100 may be applied to an Internet protocol television (IPTV) system, as shown in FIG. 2, but the present invention is not restricted to this. According to other aspects of the present invention, the apparatus 100 may be applied to, for example, an outdoor advertising system or a tool to edit moving image data, music data or still image data.

During the broadcast of an IPTV program, broadcast content, which is organized by the apparatus 100, is transmitted to an IP set-top box 140 through the Internet 120. Then, the broadcast content is reproduced by an IPTV 160. The apparatus 100 may be associated with a content providing server (e.g., a broadcasting station server) to provide content, or at least part of the apparatus 100 may be implemented in a content providing server. However, aspects of the present invention are not restricted to this. For example, if a user organizes content present in a user device (e.g., a personal computer (PC), a mobile phone, a personal digital assistant (PDA)) and registers the result of the organization with a content providing server, the apparatus 100 may be implemented in the user device. The IPTV 160 may be seen as an example of a content reproduction apparatus, which may also be, for example, a radio, mobile device, video game console, or the like.

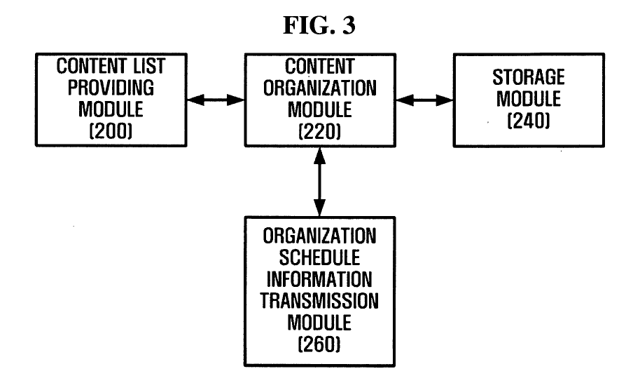

FIG. 3 shows the apparatus 100, according to an embodiment of the present invention. The apparatus 100 includes a content list providing module 200, a content organization module 220, a storage module 240 and an organization information transmission module 260. According to other aspects of the present invention, the apparatus 100 may include additional and/or different modules. Similarly, the functionality of two or more of the above modules may be integrated into a single component. The organization information transmission module 260 may be seen as an example of a communication module to communicate with other devices or with a content provider.

The content list providing module 200 creates a list of content present in a content providing server, in a data base associated with a content providing server, or in a user device, and provides the content list to the content organization module 220. The content organization module 220 may provide a user with a graphical user interface (GUI) (hereinafter referred to as the content organization interface) to organize content. The organization of content with the use of the content organization interface may be interpreted as determining when to transmit the content to the user. Thus, the transmission of contents may be prevented at times other than those scheduled.

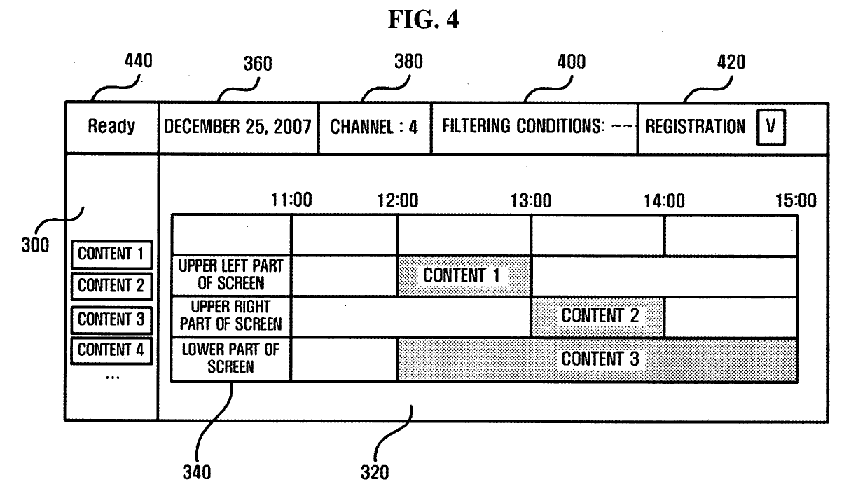

An example of the organization of content along a time axis of a content organization interface is shown in FIG. 4. As shown in FIG. 4, a content organization interface includes a content list field 300 which presents a content list provided by the content list providing module 200 and a content organization field 320 which is used to organize content along a time axis of the content organization interface. A user may drag desired content from the content list field 300 and drop the desired content in the content organization field 320 so that the desired content can be placed in a desired time period.

The user may intuitively recognize the reproduction duration, the reproduction start time and the reproduction end time of each content from the content organization interface. For example, as shown in FIG. 4, the user may intuitively recognize, with reference to the content organization interface, that content 1 is scheduled to be reproduced for one hour from 12:00 to 13:00, that content 2 is scheduled to be reproduced for one hour from 13:00 to 14:00, and that content 3 is scheduled to be reproduced for three hours from 12:00 to 15:00.

A Y axis 340 of the content organization field 320 indicates screen positions on which content 1 through 3 are to be reproduced. Content 1 is scheduled to be reproduced on an upper left portion of the screen, content 2 is scheduled to be reproduced on an upper right portion of the screen, and content 3 is scheduled to be reproduced on a lower part of the screen. However, aspects of the present invention are not restricted to this. The area on the screen may be divided in various manners, other than as shown in FIG. 4. Alternatively, content 1 through 3 may be set to be sequentially reproduced one after another on the entire screen. The content organization interface may also include a screen arrangement edition field which is used to modify the arrangement of content on the screen. In this case, the user may modify the reproduction position of desired content by dragging the desired content and dropping the desired content at a desired position in the screen arrangement edition field. The organization of content may be performed on a day-by-day basis. Various content may be organized in units of time periods in each day. For this purpose, the content organization interface may also include a date selection field 360 enabling the user to select a certain date (year/month/day).

The content organization interface may also include at least one of a channel selection field 380 enabling the user to select a certain channel; a filtering condition input field 400 enabling the user to input a number of filtering conditions for the content displayed in the content list field 300; and an organization schedule information registration field 420 including a checkbox to choose whether to register organization schedule information, which is obtained by the organization of content, with the storage module 240. Thus, the content organization interface may include any or all of the above fields. However, aspects of the present invention are not restricted to this.

If a channel selected by the user is input to the channel selection field 380, a content list including a number of content provided by the selected channel may be displayed in the content list field 300. The user is then able to organize the content provided by the selected channel in units of time periods in each day.

Once the filtering conditions are input to the filtering condition input field 400, a content list including content that satisfies the input filtering conditions may be displayed in the content list field 300. If the user checks the checkbox in the organization schedule information registration field 420, organization schedule information regarding the organization of content may be stored in the storage module 240.

If the organization of content for a certain day is complete, information indicating whether the reproduction of the content has already been performed may be displayed in a field 440. For example, if the field 440 states ‘Done,’ the organization of content for a certain day and the reproduction of the content organized for the certain day have both already been performed. If the field 440 states ‘Ready,’ only the organization of content for the certain day has already been performed. If the field 440 states ‘None,’ even the organization of content for the certain day has not yet been performed.

The reproduction durations of the content displayed in the content organization field 320 may be adjusted using the same method as that used in a word processor, such as MS Word, to adjust the width of a table, but aspects of the present invention are not limited to this.

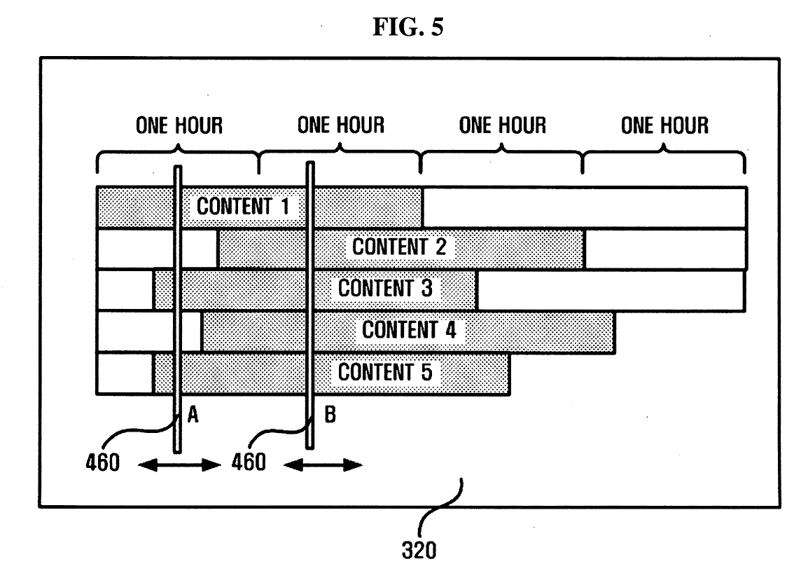

The reproduction durations of the content displayed in the content organization field 320 may be adjusted individually or collectively at the same time. In order to simultaneously adjust the reproduction durations of the content displayed in the content organization field 320, the content organization field 320 may also include a time adjustment bar 460, which enables the user to modify the temporal arrangement of the content displayed in the content organization field 320, as shown in FIG. 5.

Referring to FIG. 5, if the user shifts the time adjustment bar 460 laterally, at least one of the reproduction duration, reproduction start time, and reproduction end time of each of content 1 through 5 currently being displayed in a content organization field 320 may be adjusted by the amount by which the time adjustment bar 460 is shifted laterally. Thus, any or all of the reproduction duration, reproduction start time, and reproduction end time may be adjusted based upon the shifting of the time adjustment bar 460. When a mouse pointer is placed on a time axis of the content organization interface, the time adjustment bar 460 may be displayed first as a dotted line. Thereafter, if a certain time on the time axis is selected, the time adjustment bar 460 may be activated and transformed into a solid line. However, aspects of the present invention are not limited to this.

If the user shifts the time adjustment bar 460 laterally when the time adjustment bar 460 overlaps one or more of content 1 through 5, the reproduction duration of each of the content overlapped by the time adjustment bar 460 may be adjusted. If the user shifts the time adjustment bar 460 laterally when the time adjustment bar 460 does not overlap any one of content 1 through 5, the reproduction start time or the reproduction end time of each of content 1 through 5 may be adjusted. However, aspects of the present invention are not limited to this.

If the user shifts the time adjustment bar 460 to the left by a predetermined amount when the time adjustment bar 460 is placed at position A, the reproduction durations of content 1, 3 and 5 may be reduced by the predetermined amount, and the reproduction start times of content 2 and 4 may be advanced by the predetermined amount. If the user shifts the time adjustment bar 460 to the right by a predetermined amount when the time adjustment bar 460 is placed at position A, the reproduction durations of content 1, 3 and 5 may be increased by the predetermined amount, and the reproduction start times of content 2 and 4 may be delayed by the predetermined amount.

If the user shifts the time adjustment bar 460 to the left by a predetermined amount when the time adjustment bar 460 is placed at position B, the reproduction durations of content 1 through 5 may all be reduced by the predetermined amount. If the user shifts the time adjustment bar 460 to the right by a predetermined amount when the time adjustment bar 460 is placed at position B, the reproduction durations of content 1 through 5 may all be increased by the predetermined amount. In short, the content organization interface enables the user to organize desired content and thus to create a schedule for the reproduction of the desired content.

The content organization module 220 stores such organization schedule information in the storage module 240 as extensible Markup Language (XML) information. The organization schedule information may include organization date information, start time information, end time information, reproduction duration information and screen position information, but the present invention is not limited to this. According to other aspects of the present invention, the organization schedule information may be stored in the storage module 240 using another format instead of XML.

The XML information present in the storage module 240 may be organically associated with the organization schedule information obtained by the user with the use of a content organization interface by the user. Thus, the XML information may be updated whenever the organization schedule information created by the user is updated through the content organization interface. In a typical document object model (DOM) for XML, each element of an XML document is deemed as an object of a tree structure. According to aspects of the present invention, objects of an XML document are respectively mapped to content that is organized along a time axis of a content organization interface.

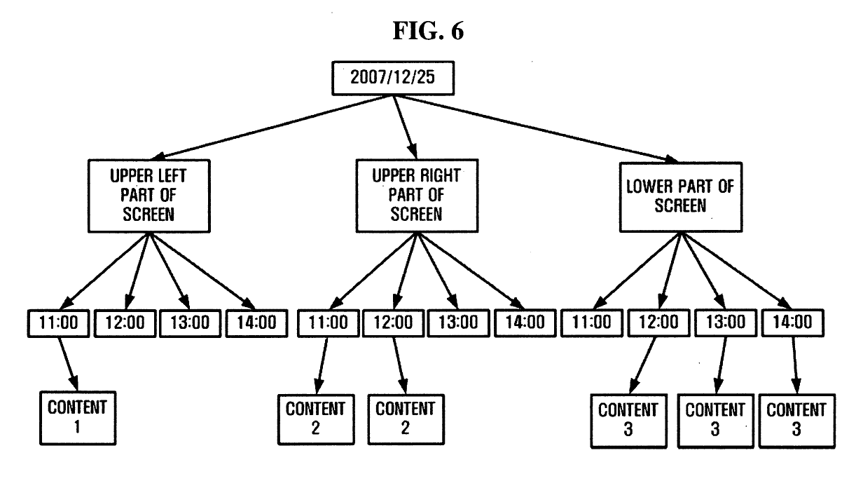

FIG. 6 shows a diagram explaining the organization of content using a tree structure, according to an embodiment of the present invention. Referring to FIG. 6, XML information may be modeled as a tree structure. A root node of the tree structure may indicate a date, such as Dec. 25, 2007, in consideration that the organization and management of content is performed on a day-by-day basis.

Three depth-1 nodes, which are directly below the root node, correspond to a Y axis of a content organization interface and indicate screen positions where contents are respectively reproduced. One or more new depth-1 nodes may be freely added to the tree structure according to the arrangement of contents on a screen. Information included in each of the three depth-1 nodes may include coordinates on the screen.

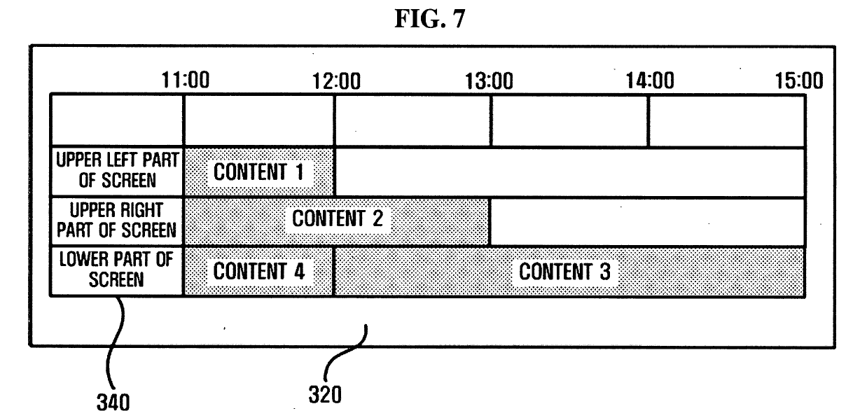

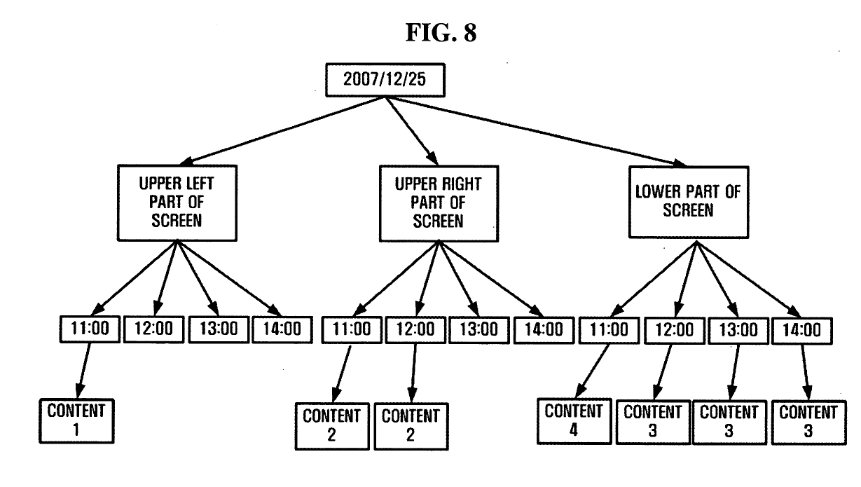

A plurality of depth-2 nodes, which are directly below the three depth-1 nodes, correspond to an X axis of a content organization interface, i.e., a time axis. The tree structure may systematically indicate content organized for each time period. If a new content is organized for a certain time period, the new content may be included in a depth-3 node corresponding to the certain time period. The addition of a content object, along a time axis, to the tree structure shown in FIG. 6 will hereinafter be described in further detail with reference to FIGS. 7 and 8.

Referring to FIG. 7, in order to add content 4, which is scheduled to be reproduced for one hour from 11:00 on a lower part of a screen, to a content organization field 320 of a content organization interface, a user may select a row corresponding to the lower part of the screen and arrange content 4 in the selected row to occupy a number of columns corresponding to the reproduction duration of content 4. Then, XML information having the tree structure shown in FIG. 6 is updated according to the addition of content 4, and this will hereinafter be described in further detail with reference to FIG. 8.

FIG. 8 shows a diagram explaining how to add new content to, or delete existing content from, the tree structure shown in FIG. 6 and how to modify an existing content in the tree structure shown in FIG. 6 according to an update in the content organization field 320 of the content organization interface shown in FIG. 7, according to an embodiment of the present invention. Referring to FIG. 8, a node for content 4, which is scheduled to be reproduced for one hour from 11:00 on Dec. 25, 2007 on a lower part of a screen, is newly added as a daughter node of a depth-2 node “11:00” below a depth-1 node “Lower Part of Screen,” which is a daughter node of a root node “Dec. 25, 2007.”

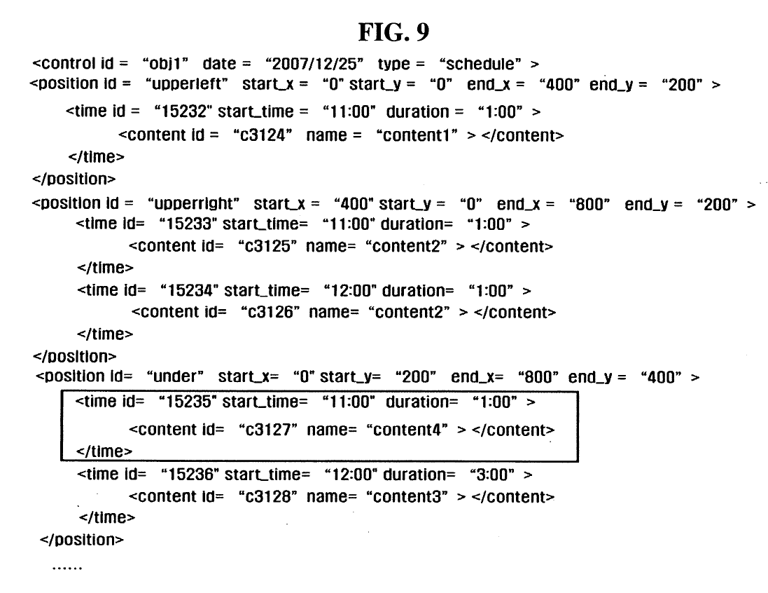

Even though only the addition of content has been described above with reference to FIGS. 7 and 8, the modification and deletion of content may be performed using a similar process. An update in the content organization field 320 of the content organization interface shown in FIG. 7 may be readily reflected into XML information, and this will hereinafter be described in detail with reference to FIG. 9.

FIG. 9 shows a diagram of XML information into which the addition of content 4 to the content organization field 320 of the content organization interface shown in FIG. 7 is reflected, according to an embodiment of the present invention. Referring to FIG. 9, a part of the XML information enclosed in a rectangular outline reflects the addition of content 4 to the content organization field 320 of the content organization interface shown in FIG. 7 is reflected. In short, organization schedule information regarding the organization of content with the use of a content organization interface may be stored in the storage module 240 (e.g., a system memory) as a tree structure. In addition, the organization schedule information may be stored in the storage module 240 as an XML document, and thus, even if a system is turned off, the organization schedule information may be reloaded from the storage module 240.

The organization information transmission module 260 transmits the organization schedule information stored in the storage module 240 to a content providing server capable of transmitting content. The content providing server may provide content to the user according to the organization schedule information transmitted by the organization information transmission module 260.

According to aspects of the present invention, it is possible to facilitate the addition of new content and the deletion and modification of an existing content by organizing and managing contents with the use of a content organization interface and an XML tree structure.

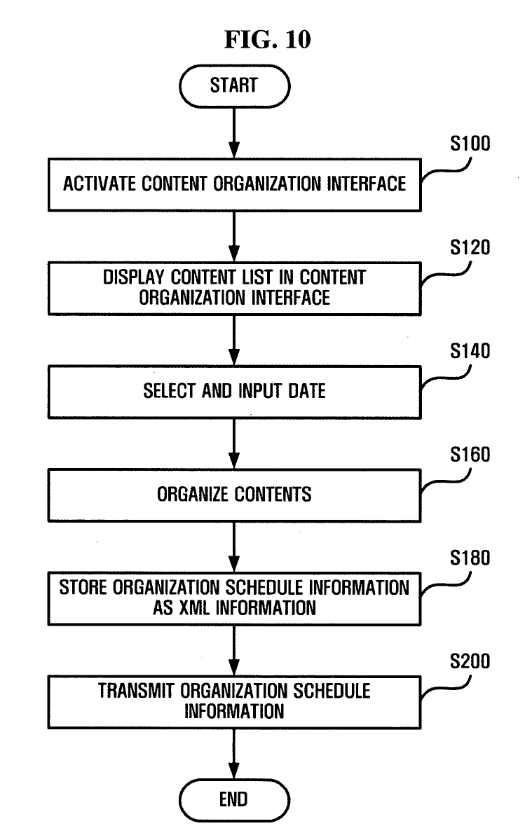

FIG. 10 shows a process of organizing contents according to an embodiment of the present invention. Referring to FIG. 10, a user activates a content organization interface in order to organize content in operation S100.

A content list is displayed in a content list field 300 of the content organization interface in operation S120. The content list displayed in operation S120 may include content stored in a content providing server, in a database associated with a content providing server, or in a user device. If the user selects a channel from a channel selection field 380 of the content organization interface or inputs a set of filtering conditions to a filtering condition input field 400 of the content organization interface, the content list displayed in operation S120 may include content provided by the selected channel or satisfying the input filtering conditions.

The user selects a date from a date selection field 360 of the content organization interface in operation S140. The user performs content organization by dragging content to be organized for the selected date from the content list field 300 and dropping each of the dragged content in a desired time period in a content organization field 320 in operation S160. The user may adjust at least one of the reproduction duration, the reproduction start time, and the reproduction end time of the content in the content organization field 320 using a time adjustment bar 460.

Thereafter, the user checks a checkbox in an organization schedule information registration field 420 of the content organization interface in order to store organization schedule information regarding the result of content organization performed in operation S160 in the storage module 240. The organization schedule information is stored in the storage module 240 as XML data in operation S180. The organization information transmission module 260 provides the XML information present in the storage module 240 to a content providing server capable of transmitting content, in operation S200. If the organization schedule information is modified through the content organization interface, the XML information present in the storage module 240 may be modified accordingly.

As described above, according to aspects of the present invention, it is possible to systematically and efficiently organize and manage content.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of organizing content, the method comprising:
creating a content list and providing the content list to a user;
providing a user interface to the user to organize content included in the content list in units of time periods;
storing organization schedule information obtained by the user interface as extensible Markup Language (XML) information; and
transmitting the organization schedule information and enabling the content to be provided to the user according to the organization schedule information.

2. The method of claim 1, wherein the XML information is organically associated with the organization schedule information, and is updated whenever the organization schedule information is updated.

3. The method of claim 2, wherein the XML information is modeled as a tree structure.

4. The method of claim 1, wherein the organization schedule information comprises at least one of organization date information, start time information, end time information, reproduction duration information, and screen position information of each item of content.

5. The method of claim 1, wherein the user interface comprises:
a content list field to present the content list; and
a content organization field to organize the content along a time axis of the user interface.

6. The method of claim 5, wherein the content is organized and arranged along the time axis of the user interface by dragging content included in the content list field and dropping the dragged content in the content organization field.

7. The method of claim 5, wherein the content organization field enables the user to choose a screen position on which each item of content is to be reproduced.

8. The method of claim 5, wherein the user interface further comprises at least one of a date selection field to select a date, a channel selection field to select a channel, a filtering condition input field to input filtering conditions, and an organization schedule information registration field to determine whether to register the organization schedule information in a storage module.

9. The method of claim 1, wherein the user interface comprises a time adjustment bar to modify a temporal arrangement of the content.

10. The method of claim 9, further comprising, if the time adjustment bar is shifted by a predetermined amount, adjusting at least one of the reproduction duration, the reproduction start time and the reproduction end time of each item of content by the predetermined amount.

11. The method of claim 10, wherein the adjusting comprises:
arranging the content along a time axis of the user interface according to the organization schedule information;
if the time adjustment bar is shifted when overlapping the content, adjusting the reproduction duration of the overlapped content based on the shifting of the time adjustment bar; and
if the time adjustment bar is shifted when not overlapping any of the contents, adjusting either the reproduction start time or the reproduction end time of each item of the content based on the shifting of the time adjustment bar.

12. An apparatus to organize content, the apparatus comprising:
a content list providing module to create a content list and to provide the content list to a user;
a storage module to store information;
a content organization module to provide, to the user, a user interface to organize content included in the content list in units of time periods and to store organization schedule information obtained by the user interface in the storage module as eXtensible Markup Language (XML) information; and
an organization schedule information transmission module to transmit the organization schedule information and to enable the content to be provided to the user according to the organization schedule information.

13. The apparatus of claim 12, wherein the XML information is organically associated with the organization schedule information, and is updated whenever the organization schedule information is updated.

14. The apparatus of claim 13, wherein the XML information is modeled as a tree structure.

15. The apparatus of claim 12, wherein the organization schedule information comprises at least one of organization date information, start time information, end time information, reproduction duration information, and screen position information of each item of content.

16. The apparatus of claim 12, wherein the user interface comprises:
a content list field to present the content list; and
a content organization field to organize the content along a time axis of the user interface.

17. The apparatus of claim 16, wherein the content is organized and arranged along the time axis of the user interface by dragging content included in the content list field and dropping the dragged content in the content organization field.

18. The apparatus of claim 16, wherein the content organization field enables the user to choose a screen position on which each item of content is to be reproduced.

19. The method of claim 16, wherein the user interface further comprises at least one of a date selection field to select a date, a channel selection field to select a channel, a filtering condition input field to input filtering conditions, and an organization schedule information registration field to determine whether to register the organization schedule information in a storage module.

20. The apparatus of claim 12, wherein the user interface comprises a time adjustment bar to modify a temporal arrangement of the content.

21. The apparatus of claim 20, wherein, if the time adjustment bar is shifted by a predetermined amount, at least one of the reproduction duration, the reproduction start time and the reproduction end time of each item of content is adjusted by the predetermined amount.

22. The apparatus of claim 21, wherein the content is arranged along a time axis of the user interface according to the organization schedule information, the reproduction duration of the content is adjusted if the time adjustment bar is shifted when overlapping the content, and either the reproduction start time or the reproduction end time of each item of contents is adjusted if the time adjustment bar is shifted when not overlapping any of the content.

23. A content organization apparatus, comprising:
a content organization module to provide a user interface to a user, the user interface allowing the user to organize content identified in a content list by time period, and to generate organization schedule information based on input from the user via the user interface; and
a communication module to receive the content list from an outside source, to transmit the organization schedule information to at least one content provider, to receive content from the at least one content provider, and to provide the received content to the user according to the organization schedule information.

24. The content organization apparatus of claim 23, further comprising:
a storage module to store the organization schedule information.

25. The content organization apparatus of claim 24, wherein the storage unit stores the organization schedule information in an extensible Markup Language (XML) format.

26. The content organization apparatus of claim 23, wherein the communication module receives the content from the at least one content provider according to the organization schedule information.

27. The content organization apparatus of claim 23, wherein the user interface comprises an axis to allow the user to indicate a screen position in which an item of content is to be reproduced.

28. The content organization apparatus of claim 23, wherein the user interface comprises an axis to allow the user to indicate a time period during which an item of content is to be reproduced.

29. A method of organizing content, comprising:
receiving a content list;
generating organization schedule information in which content included in the content list is organized based on time periods, the organization schedule information being generated based on input from a user via a user interface;
transmitting the organization schedule information to at least one content provider;
receiving content from the at least one content provider; and
providing the content to the user according to the organization schedule information.

30. The method of claim 29, wherein the generating of the organization schedule information comprises generating the organization schedule information in an extensible Markup Language (XML) format.

31. The method of claim 30, wherein the generating of the organization schedule information comprises generating the organization schedule information as an XML tree structure.
